(19) United States
(12) Patent Application Publication
(10) Pub. No.: US 2013/0011621 A1
(43) Pub. Date: Jan. 10, 2013

(54) SUPPORT STRUCTURES INCLUDING LOW TACK VISCOELASTOMERIC GEL MATERIAL AND METHODS

(75) Inventors: David Dale Russell, Grove City, OH (US); Kevin Fredrick Callsen, Cleveland, OH (US)

(73) Assignee: POLYMER CONCEPTS, INC., Mentor, OH (US)

(21) Appl. No.: 13/543,250

(22) Filed: Jul. 6, 2012

Related U.S. Application Data
(60) Provisional application No. 61/505,822, filed on Jul. 8, 2011.

(51) Int. Cl. C08L 75/04; B32B 3/30; B05D 5/00

(52) U.S. Cl. 428/159; 427/256; 524/871

(57) ABSTRACT

A low tack viscoelastomeric gel material formed by combining, by percent weight: about 50% to about 80% of a Polyol; about 3% to about 15% of an isocyanate; about 15% to about 40% of an oil; about 0.1% to about 1% of a catalyst; and about 0% to about 1% of a release agent. Support structures are also provided with a layer of low tack viscoelastomeric gel material. Further aspects also include methods of making the low tack viscoelastomeric gel material and methods of making support structures with a layer of low tack viscoelastomeric gel material.

### CROSS-REFERENCE TO RELATED APPLICATIONS

This application claims the benefit of U.S. Provisional Application No. 61/505,822, filed Jul. 8, 2011, the entire disclosure of which is hereby incorporated herein by reference.

### FIELD OF THE INVENTION

The present invention relates generally to viscoelastomeric gel material, support structures and methods, and more particularly, to low tack viscoelastomeric gel material, support structures including low tack viscoelastomeric gel material and methods of making the low tack viscoelastomeric gel material and support structures with the low tack viscoelastomeric gel material.

### BACKGROUND OF THE INVENTION

Conventional support structures are frequently used to enhance comfort of body portions being supported against the force of gravity. For example, it is known to provide conventional support structures with a foam material configured to support body portions. It is also known to provide a composite support structure with different density materials. However, known support structures may not provide a desired support characteristic, may be excessive in weight, and/or may be relatively expensive to produce.

Viscoelastic gels have been known, for example silicone types, oil gels or styrene-butadiene block copolymers, hydrogels, and polyurethane gels. However, when making prior viscoelastic gels soft enough for useful support structures these prior art gels are very tacky and may bleed oils onto adjacent structures. To mitigate these disadvantages said gels are typically encapsulated in a membrane or must be coated with a dusting agent such as talc, starch, or the like.

### BRIEF SUMMARY OF THE DISCLOSURE

The following presents a simplified summary of the disclosure in order to provide a basic understanding of some example aspects of the disclosure. This summary is not an extensive overview of the disclosure. Moreover, this summary is not intended to identify critical elements of the disclosure nor delineate the scope of the disclosure. The sole purpose of the summary is to present some concepts of the disclosure in simplified form as a prelude to the more detailed description that is presented later.

In accordance with one aspect of the disclosure, a support structure comprises a first layer of foam material including a first side with a plurality of protrusions and a plurality of channels, wherein the protrusions each include a first support surface substantially facing a first direction. The support structure further includes a second layer of low tack viscoelastomeric gel material disposed within the plurality of channels, wherein the second layer includes a second support surface substantially facing the first direction and disposed laterally with respect to each first support surface.

In accordance with another aspect, a method of making a support structure comprises the steps of providing a first layer of foam material including a first side with a plurality of protrusions and a plurality of channels, wherein the protrusions each include a first support surface; dispensing a liquid material into the plurality of channels to a liquid level; and curing the dispensed liquid into a second layer of low tack viscoelastomeric gel material such that a second support surface is formed at the liquid level.

In accordance with yet another aspect, a low tack viscoelastomeric gel material is formed by combining, by percent weight: about 50% to about 80% of a Polyol; about 3% to about 15% of an isocyanate; about 15% to about 40% of an oil; about 0.1% to about 1% of a catalyst; and about 0% to about 1% of a release agent.

In still another aspect, a method of making a low tack viscoelastomeric gel material comprising the steps of dispensing a liquid material comprising, by percent weight of the liquid material: about 50% to about 80% of a Polyol, about 3% to about 15% of an isocyanate, about 15% to about 40% of an oil, about 0.1% to about 1% of a catalyst, and about 0% to about 1% of a release agent; and curing the dispensed liquid material into a low tack viscoelastomeric gel material.

### BRIEF DESCRIPTION OF THE DRAWINGS

The foregoing and other aspects of the present invention will become apparent to those skilled in the art to which the present invention relates upon reading the following description with reference to the accompanying drawings, in which:

FIG. 1 a top view of an example support structure including aspects of the present invention;

FIG. 1A is a sectional view of the support structure along line 1A-1A of FIG. 1, illustrating portions of a first layer of foam material, a second layer of viscoelastomeric gel material, and a third layer extending over portions of the first layer and the second layer;

FIG. 1B is a sectional view of the support structure along line 1B-1B of FIG. 1, illustrating further portions of the first, second and third layers;

FIG. 2 is a top view of the example support structure of FIG. 1 without the third layer;

FIG. 2A is a sectional view of the support structure along line 2A-2A of FIG. 2;

FIG. 2B is a sectional view of the support structure along line 2B-2B of FIG. 2;

FIG. 3 is a top view of the example support structure of FIG. 1 without the first and second layers;

FIG. 4 illustrates an example method of making a support structure including the step of dispensing liquid into a plurality of channels of a first layer of foam material;

FIG. 5 is a sectional view of a support structure in accordance with another example of the present invention;

FIG. 6 is a sectional view of a support structure in accordance with still another example of the present invention;

FIG. 7 is a view of an example exercise ball in accordance with aspects of the disclosure; and

FIG. 8 is a flow chart illustrating a method of making a low tack viscoelastomeric gel material.

### DESCRIPTION OF EXAMPLE EMBODIMENTS

Example embodiments that incorporate one or more aspects of the present invention are described and illustrated in the drawings. These illustrated examples are not intended to be a limitation on the present invention. For example, one or more aspects of the present invention can be utilized in other embodiments and even other types of devices. Moreover, certain terminology is used herein for convenience only and is not to be taken as a limitation on the present invention. Still further, in the drawings, the same reference numerals are employed for designating the same elements.

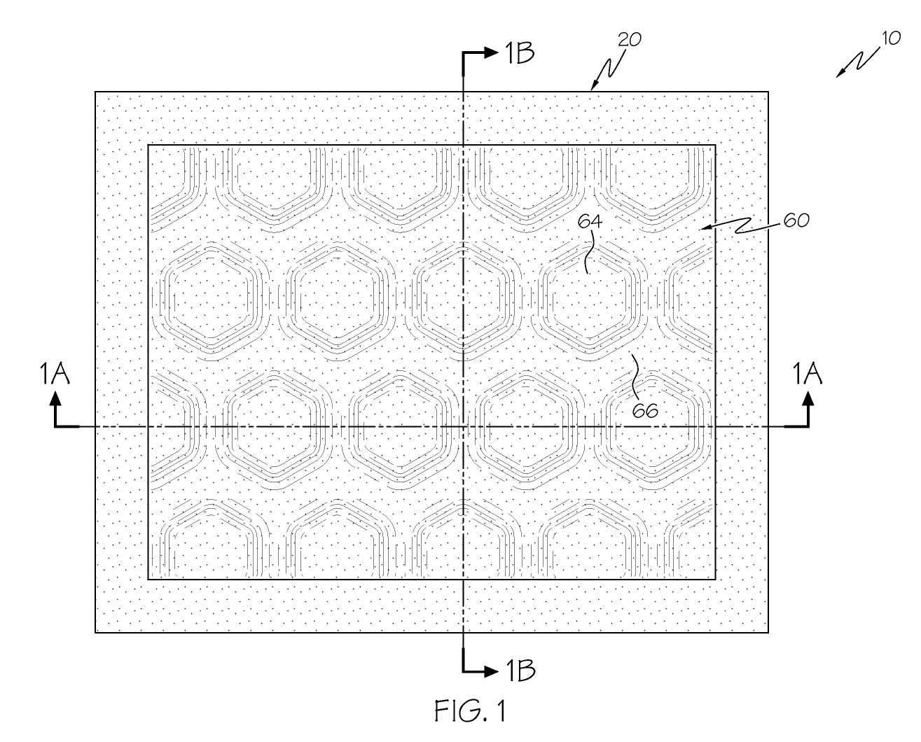

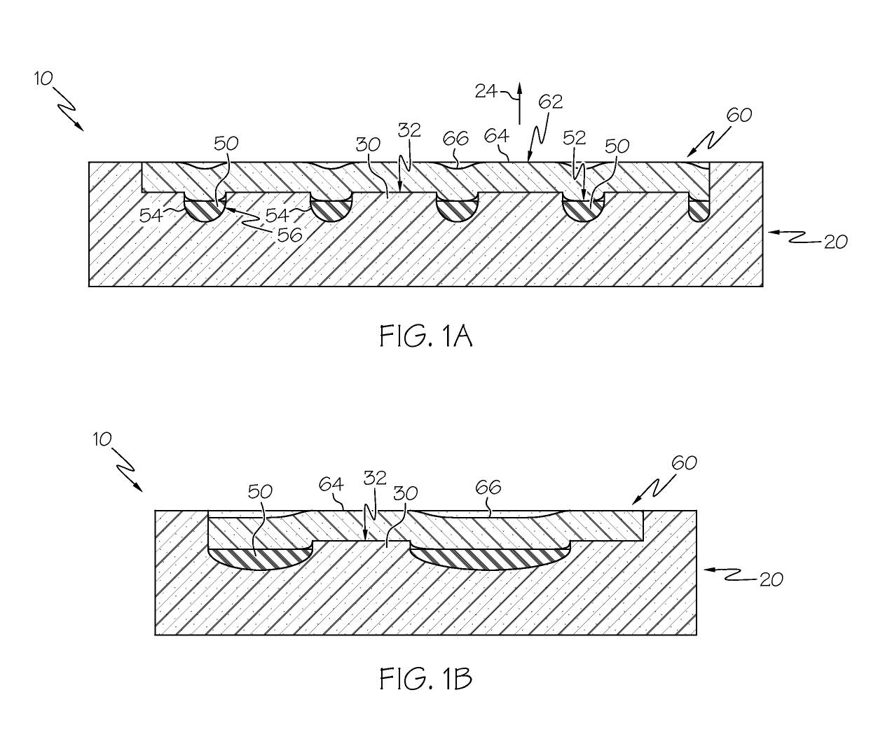

FIGS. 1, 1A and 1B illustrate an example support structure 10 incorporating aspects of the present invention. Example support structures incorporating aspects of the present invention may be used independently in a wide range of applications. For instance, support structures may be used as a stand-alone element for creature comfort or other support applications. Support structures incorporating aspects of the present invention can also be used in combination with other elements for creature comfort or other support applications.

Example support structures may be provided as a support pad for the hands, arms, legs, head, and/or other areas of an individual to provide a comfortable support surface for an area of the individual's body. In still further examples, support structures may be provided as a seat cushion to provide an individual with a comfortable seating surface. In yet additional examples, the support structures may be provided as a large support pad that can be used as a sleeping surface to support areas of the individual's body for a comfortable resting surface.

Example support structures can also be placed inside of another configuration to provide an overall comfortable support surface. For instance, a cushion may incorporate the support structure to allow the cushion to more effectively support an area of the individual's body. Still further, the support structures may be placed inside a mattress pad for placing over a mattress. In addition, or alternatively, the support structures may comprise a mattress insert placed within a portion of a mattress to provide a comfortable sleeping area for an individual.

Support structures can also be incorporated into sleeping or resting areas for animals such as dogs, cats or other pets. For instance, support structures may be provided for animals around the home, in a cage, car, or other area.

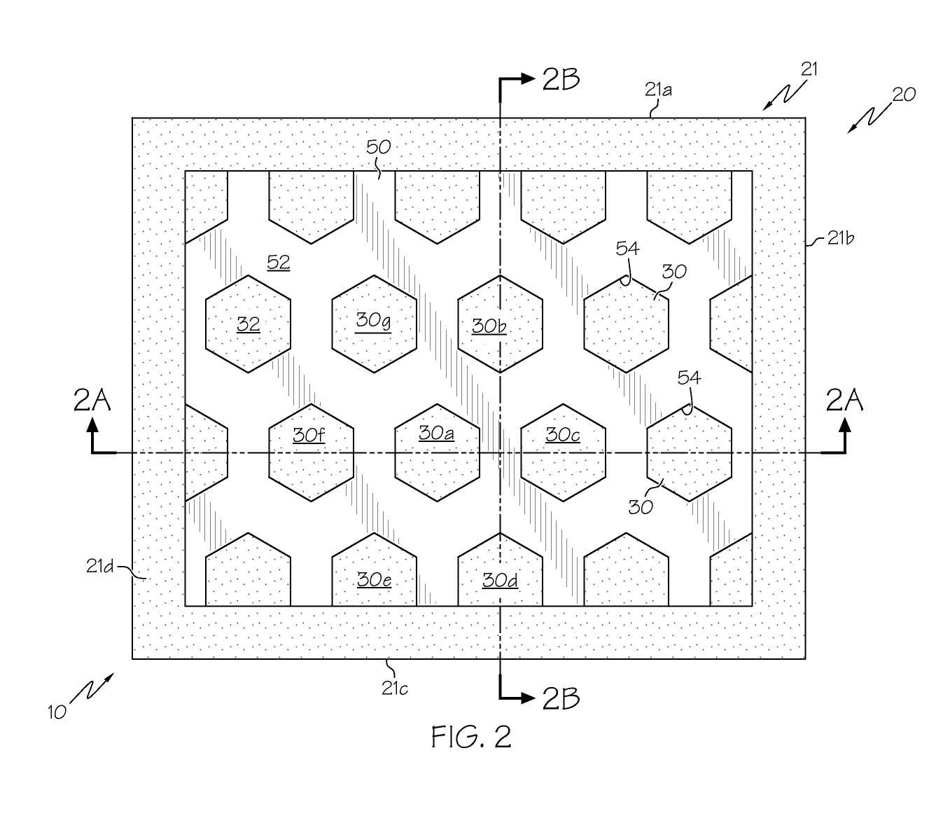

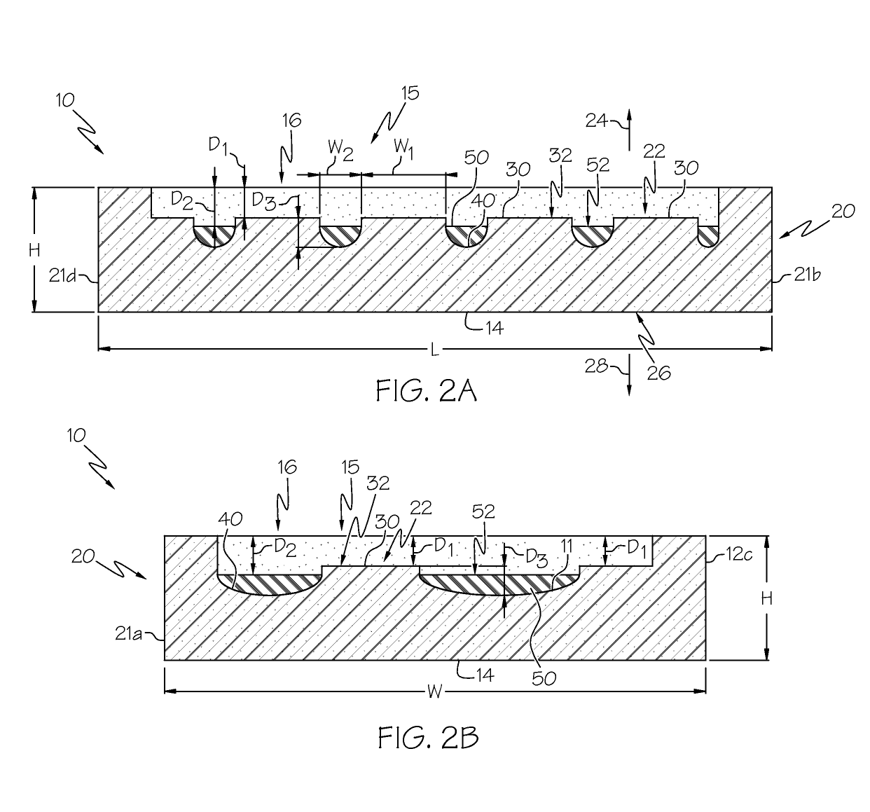

As shown in FIGS. 1, 1A, 1B, 2, 2A and 2B, the support structure 10 includes a first layer 20 of foam material and a second layer 50 of low tack viscoelastomeric gel material. The first layer 20 of foam material can include a first side 22 and a second side 26. As shown in the illustrated example, the first and second sides 22, 26 of the first layer 20 of foam material can be oriented to face substantially opposite directions. For instance, as shown, the first side 22 can face a first direction 24 and the second side 26 can face a second direction 28 opposite the first direction 24. It is to be appreciated that the first and second sides may face in other directions with respect to one another in further examples.

The first side 22 of the first layer 20 of foam material can include a plurality of protrusions 30 and a plurality of channels 40. The protrusions 30 can include a first support surface 32 that may face in a variety of directions. For instance, as shown, the first support surface 32 can be designed to substantially face the first direction 24. In the illustrated example, the protrusions 30 can comprise columns that can be spaced from one another and formed with a wide range of shapes and sizes. Example columns may be provided with a substantial polygonal shape. For instance, the columns may include a triangular, rectangular (e.g., square), or other polygon with three or more sides. For example, as shown in FIGS. 2-4, the protrusions 30 are formed as columns with six sides in the shape of a hexagon. Although all sides of the six-sided columns are illustrated as substantially flat surfaces with a straight profile when viewed from the top, it is contemplated that one or more sides may comprise curved surfaces, a plurality of straight profile segments and/or other shapes or configurations with one or more alternative profiles.

Although the protrusions 30 are illustrated as columns that are substantially polygonal in shape, it is contemplated that the columns may include other shapes. For example, although not shown, it is contemplated that the columns can include a circular, oval, D-shape or other shapes.

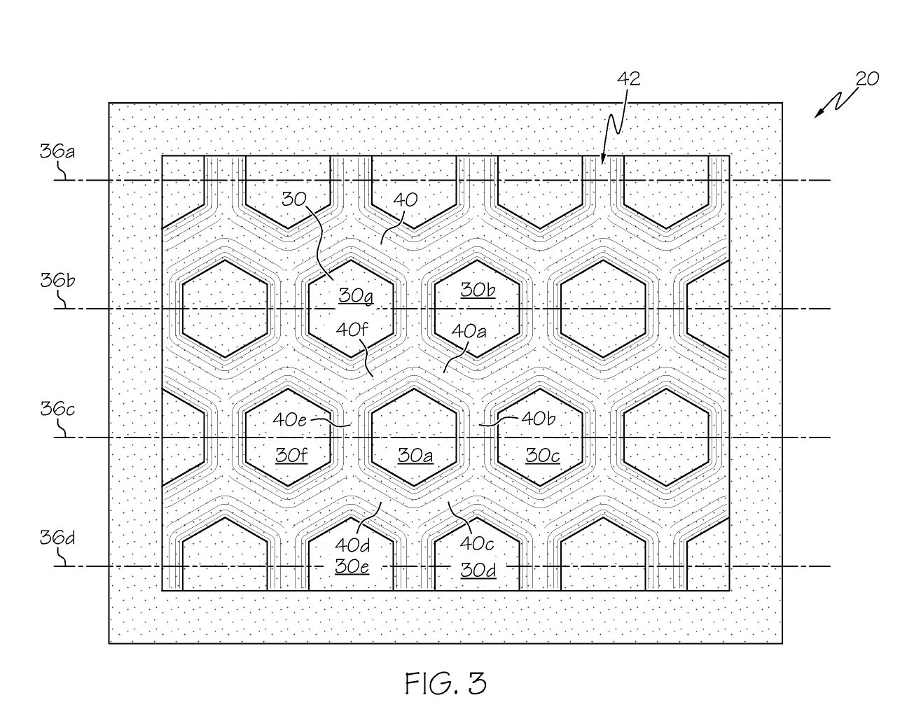

The plurality of channels 40 can be provided in a wide variety of configurations. As shown in FIG. 3, the plurality of channels 40 can comprise a network 42 of channels surrounding at least one of the plurality of protrusions 30. For instance, as shown, the plurality of channels 40 comprises a network 42 of channels that surrounds a plurality of inner protrusions 30 and segregates adjacent protrusions from one another. As shown in FIG. 3, several of the columns have been labeled to illustrate a central column 30a and adjacent columns 30b-g. As shown, the central column 30a can be surrounded by six adjacent columns 30b-g and the network 42 of channels can include six channels 40a-f. Each of the six channels can be respectively spaced between the central column 30a and a respective one of the adjacent columns 30b-g.

The channels may be substantially different shapes and sizes and can be configured to provide a reservoir area for the second layer 50 of low tack viscoelastomeric gel material. The channels can be designed to all be in communication with one another. For example, as shown, the network 42 of channels includes a plurality of channels that are all in communication with one another. In further examples, at least some of the channels may be isolated from one another. For instance, a first set of channels may be provided in communication with one another and one or more channels may be provided that are not in communication with the first set of channels. In further examples, the channels may comprise single isolated channels that are parallel or offset from one another. For instance, the channels may comprise a series of isolated substantially straight channels that are offset from one another. In further examples, the series of isolated channels may comprise curved channels (e.g., having a sinusoidal shape) or other shape that are offset from one another. In further examples, the channels may be cut or otherwise formed in foam in a wide variety of patterns.

The channels 40 can also comprise a wide variety of shapes and sizes. For instance, the channels have different or identical depths and widths. Moreover, the cross-sectional profile of the channels can vary in accordance with aspects of the present invention. For example, referencing FIGS. 2A and 2B the channels have a substantially U-shape with an arcuate lower surface. In further examples, the channels can have a substantially U-shape with a substantially flat lower surface although other shapes may be used in further examples.

As shown in the illustrated example, the plurality of protrusions 30 can be arranged in an array of protrusions. In one example, the array of protrusions can comprise a matrix of protrusions with alternate rows of protrusions that are sequentially laterally aligned with one another. With such an arrangement, each row of protrusions are vertically aligned with one another to form vertically aligned columns of protrusions wherein each column includes a protrusion from each row. In some examples, the vertical spacing between adjacent protrusions can be substantially identical to the horizontal spacing between adjacent protrusions. Such a matrix of protrusions may be beneficial for use with protrusions comprising a square shaped column although other shapes may be used in further examples. Using the square shaped columns with the matrix of protrusions can provide square shaped columns that are spaced from one another such that each of the four sides face another side of another adjacent square shaped column.

As shown in FIG. 3, the array of protrusions can also comprise alternate rows 36a, 36b of protrusions that are sequentially laterally offset from one another. In one example, such an arrangement can provide every other row of protrusions being vertically aligned with one another. For instance, as shown in FIG. 3, rows 36a and 36c include alternate rows of protrusions that are vertically aligned while rows 36b and 36d similarly include alternate rows of protrusions that are vertically aligned. As shown in FIG. 3, such an array of protrusions may be beneficial, for example, with protrusions comprising columns with a hexagonal shape although other shapes may be used in further examples. As shown, the array of hexagonal columns can be spaced from one another such that each of the six sides faces a side of another hexagonal column. As shown in FIG. 2, the central column 30a is surrounded by six adjacent columns 30b-g that are spaced from the central column 30a. In one example, the columns are equally radially spaced from one other although other arrangements may be used in further configurations. Moreover, each face of the central column 30a is substantially parallel to and faces a corresponding face of a respective adjacent column 30b-g.

As shown in FIGS. 2A and 2B, the first support surface 32 of the columns may be recessed a distance (D₁) within an interior area 16 of the support structure 10 although the first support surface 32 of the columns may be the same height as the peripheral wall 21 in further examples. Moreover, as shown, all of the columns are recessed substantially the same distance (D₁). In further examples, the first support surface 32 of one or more of the columns may be recessed different distances and may even extend higher than the peripheral wall 21 in further examples. As shown, the first support surface 32 of the columns may be substantially planar in shape although the first support surface of the columns may also be convex, concave or have ribbed portions, wave patterns, or other surface characteristics in further examples.

As shown in FIGS. 2, 2A and 2B, the first layer 20 of foam material can include a peripheral wall 21 having a height (H) extending around the peripheral wall 21. In the illustrated example, the peripheral wall 21 includes four sides 21a, 21b, 21c, 21d although more or less than four sides may be provided in further examples. For instance, the peripheral wall 21 can include a single side with a circular, oval or other shape. Furthermore, although each of the plurality of sides include a substantially linear extent, it is contemplated that at least a portion of the wall can have an arcuate portion.

As further shown in FIGS. 2A and 2B, the example first layer 20 of foam material can further include a bottom wall 14 extending between the side walls 21a, 21b, 21c, 21d. As shown, the bottom wall 14 can have a substantially planar bottom surface although other surface characteristics may be provided in further examples. In the illustrated example, the bottom wall 14 closes the bottom portion of the support structure 10. As further shown, the side walls 21a, 21b, 21c, 21d define an opening 15 into the interior area 16 of the support structure 10.

As shown in FIGS. 2, 2A and 2B, the second layer 50 of low tack viscoelastomeric gel material can be disposed within the plurality of channels 40 and provided with a second support surface 52 facing the first direction 24 and disposed laterally with respect to each first support surface 32. As shown, the second layer 50 of low tack viscoelastomeric gel material can be disposed in the network 42 of channels to define a network of gel material. As shown, the second layer 50 of low tack viscoelastomeric gel material can be arranged such that the second support surface 52 surrounds at least one of the plurality of protrusions 30. As shown in FIG. 2 for example, the second support surface 52 completely surrounds a plurality of inner protrusions. As further illustrated, the second support surface 52 can partially surround peripheral protrusions. It is also contemplated that the second support surface may partially surround at least some or all of the inner protrusions in further examples. Moreover, as shown, the second layer 50 of low tack viscoelastomeric gel material can be provided as a single network of gel material although two or more separate networks or gel portions maybe provided in further examples.

As shown in FIGS. 2A and 2B, the protrusions 30 can be designed to extend at least partially through the second layer 50 of low tack viscoelastomeric gel material with the second support surface 52 disposed laterally with respect to each first support surface 32. For example, as shown in FIG. 2, the second layer 50 of low tack viscoelastomeric gel material can include a plurality of through apertures 54 with the plurality of protrusions 30 each extending at least partially through a corresponding aperture of the plurality of apertures 54. As shown in FIG. 1A, each aperture 54 can include an interior surface 56 bonded to the corresponding protrusion 30 extending at least substantially through the aperture 54.

As shown in FIGS. 2A and 2B, the second layer 50 of low tack viscoelastomeric gel material is filled such that the level of the second layer 50 of low tack viscoelastomeric gel material extends to a recessed distance (D₂) within the interior area 16 of the first layer 20 of foam material. As shown, the recessed distance (D₁) of the first support surface 32 of the protrusions 30 is less than the recessed distance (D₂) of the second support surface 52 of the second layer 50 of low tack viscoelastomeric gel material. As such, the first support surface 32 of the protrusions 30 form a plurality of islands that are separated from one another by the second layer 50 of low tack viscoelastomeric gel material. Moreover, the first support surface 32 of each protrusion 30 is positioned at a respective vertical distance above the second support surface 52 of the second layer 50 of low tack viscoelastomeric gel material.

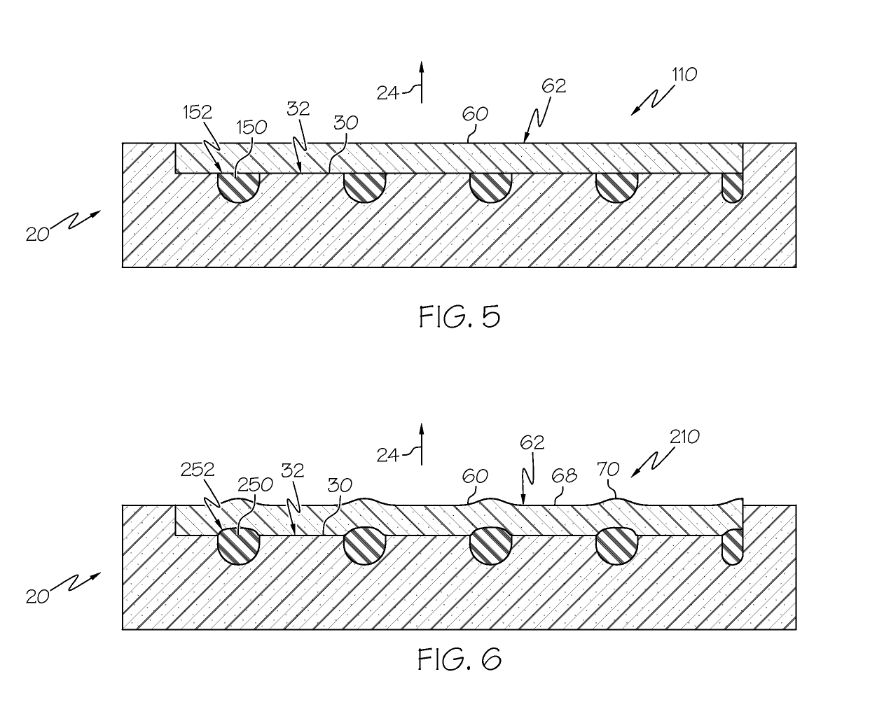

In further examples, the recessed distances (D₁, D₂) may be substantially equal to one another. For example, FIG. 5 is a sectional view of another support structure 110 similar to the support structure 10 of FIG. 1A, except the first support surface 32 of each of the protrusions 30 is substantially flush with respect to the second support surface 152 of the second layer 150.

In still further examples, the recessed distance (D₁) may be greater than the recessed distance (D₂). If the recessed distance (D₁) is greater than the recessed distance (D₂), the first support surface of one or more of the protrusions may or may not be covered by the second layer of low tack viscoelastomeric material. For example, FIG. 6 is a sectional view of another support structure 210 similar to the support structure 10 of FIG. 1A, except the first support surface 32 of each of the protrusions 30 is positioned at a respective vertical distance below the second support surface 252 of the second layer 250 of low tack viscoelastomeric gel material. Moreover, it is noted that the second layer 250 of low tack viscoelastomeric gel material does not cover the first support surface 32 of the protrusions. Although not shown, the second layer of low tack viscoelastomeric gel material may partially or entirely cover the support surface of one of more of the protrusions.

The support structure of any of the embodiments herein can further include an optional third layer 60 extending over the first support surface of the protrusions and the second support surface of the second layer. For example, with reference to FIGS. 1, 1A and 1B, the support structure 10 includes a third layer 60 extending over the first support surface 32 of the protrusions 30 and the second support surface 52 of the second layer 50 of low tack viscoelastomeric gel material. The third layer 60 includes a support surface 62 that can substantially face in the first direction 24.

As shown in FIGS. 1A and 1B, third layer 60 may be provided to close an opening 15 into the interior area 16 of the first layer 20 of foam material. An adhesive may be used to attach first and third layers 20, 60 together. Alternatively, as shown, the second layer 50 of low tack viscoelastomeric gel material may act as an adhesive to join the first and third layers 20, 60 together. In such an example, the third layer 60 may be pressed against the liquid material that forms the low tack viscoelastomeric gel material prior to curing of the low tack viscoelastomeric gel material. Thus, the second layer 50 of low tack viscoelastomeric gel material may act to bond the third layer 60 to the first layer 20 of foam material. Alternatively, the third layer 60 may be positioned over the second layer 50 without adhering to the second layer 50. The non-adhering positioning can be provided by applying the third layer 60 after the liquid material is cured to form the low tack viscoelastomeric gel material. As the viscoelastomeric gel material is a “low tack” gel material, little if any adhesion may be provided between the third layer 60 (or other surfaces if the third layer is not provided).

Use of the low tack viscoelastomeric gel material to join the first and third layers 20, 60 together (i.e., by pressing the layers together before liquid material fully cures to the low tack viscoelastomeric gel material) can result in various topographies along the support surface 62 of the third layer 60. For instance, as shown in FIGS. 1, 1A and 1B, due to the fact that (D₁) is less than (D₂), the areas of third layer 60 that are attached to the second layer 50 are pulled down such that, when viewed from the top, a plurality of support mounds 64 are surrounded by a plurality of support channels 66. The support mounds 64 are caused by the first support surface 32 of the plurality of protrusions 30 pressing against the third layer 60. The support mounds 64 may therefore be each vertically aligned with a corresponding one of the protrusions 30 of the first layer 20 of foam material. The pulled down areas of the third layer 60 can also define support channels 66 that follow the pattern of the support surface 52 of the second layer 50.

In another example, as shown in FIG. 5, the first support surface 32 of each of the protrusions 30 is substantially flush with respect to the second support surface 152 of the second layer 150. As a result the support surface 62 of the third layer 60 is substantially planar.

Still further, as shown in FIG. 6, the first support surface 32 of each of the protrusions 30 is positioned at a respective vertical distance below the second support surface 252 of the second layer 250 of low tack viscoelastomeric gel material. As a result, areas of third layer 60 that are attached to the second layer 50 are pulled down such that, when viewed from the top, a plurality of support depressions 68 are surrounded by a plurality of support ribs 70. The support depressions 68 can be caused by an adhesive layer applied to the first support surface 32 of the plurality of protrusions 30 to pull against the third layer 60. The second support surface 52 of the second layer 50 can be adhered to portions of the third layer 60 and can push portions of the third layer up and around the support depressions 68 to defined the support ribs 70.

The third layer 60 can comprise a foam material although other nonfoam materials may be used in further examples. For example, the third layer may comprise a thin polyurethane layer or other thin layer of membrane material. Similar or different foam materials may be used to form the first layer 20 and the third layer 60. In the illustrated example, the third layer 60 comprises a foam material that is identical to the foam material of the first layer 20. A wide range of foam materials may be used to fabricate the first layer 20 and the third layer 60. For instance, a flexible foam material may be used in accordance with aspects of the present invention. The illustrated foam material of the first layer 20 and the third layer 60 are provided as open cell foam although other types of foam such as a closed cell foam may be used in accordance with further aspects of the invention. In the illustrated example, the foam material may have a shape memory wherein the foam material is capable of being temporarily deformed under force, but substantially regains its original shape after the force is removed.

The second layer 50 of low tack viscoelastomeric gel material can be formed from a wide range of low tack viscoelastomeric gel material. “Low tack” means that once cured, the viscoelastomeric gel material is substantially resistant to sticking or adhering to other surfaces. In one example, the low tack gel material comprises a self-contained gel material. For instance, in one example, the low tack viscoelastomeric gel material comprises a crosslinked gel material capable of retaining its shape. Moreover, the low tack gel material is configured to bond to the first layer 20 and may optionally be configured to bond to the third layer 60 depending on whether the third layer is applied before or after curing the liquid material into the low tack viscoelastomeric gel material. For example, after dispensing as discussed below, the liquid material can at least partially permeate into the foam cell structure forming the channels and or the surface of the third layer 60 contacting the liquid material. Once cured, the low tack viscoelastomeric gel material cross-links to form a bonding interface between the now low tack viscoelastomeric gel material and the corresponding foam material.

In another example, the low tack viscoelastomeric gel material can comprise a polyurethane gel material although other gel materials may be used in further examples. The low tack viscoelastomeric gel material can have a shape memory that allows the gel material to be temporarily deformed under force, but substantially regain its original shape after the force is removed. The second layer 50 of low tack viscoelastomeric gel material can have a density that is greater than the density of the first layer 20 and the third layer 60. A wide range of low tack viscoelastomeric gel materials can be used in accordance with the present invention. Moreover, the various types of useful viscoelastomeric gel materials can provide the support structure 10 with different support characteristics than the first layer 20 and the second layer 50.

An example of a viscoelastic viscoelastomeric gel would be a polyurethane gel prepared by mixing together and reacting one or more polyisocyanate type reactants with one or more polyhydroxyl type reactants. The method of the foregoing may be step wise process such as that which is commonly referred to as a “prepolymer” process, or the process may be conducted in a single step as commonly referred to as a “one shot” process. Said reactant mixtures may contain one or more adjuvants such as plasticizers, amine or alcohol amine type curatives, catalysts, colorants, lubricants, mold releases, or the like. Examples of polyisocyanates which may be useful for making the gel of the present invention include; monomeric aliphatic or aromatic diisocyanates, isocyanate functional prepolymers, isocyanate quasi-prepolymers, and or mixtures of two or more of the foregoing. Examples of polyhydroxy reactants which may be useful for making the gel of the present invention include; monomeric diols, triols or quadrols; polymeric diols, triols or quadrols. Polymeric diols may include polyester, polyether, and or polybutadiene polyols. Examples of catalysts which may be useful for making the gel of the present invention include; organo metallic types such as tin, titanium, bismuth esters or amine type catalysts. Examples of plasticizers which may be useful for making a viscoelastic gel of the present invention include; hydrocarbon oils such as mineral oil, naphthenic oil, and the like; ester plasticizers such as phthalate, benzoate, ether-esters; vegetable oils such as corn oil, soy oil, canola oil and the like; and modified vegetable oils such as esterified, oxidized or epoxidized vegetable oils. More information on elastomeric polyurethanes can be found in references such as: “Polyurethanes Chemistry and Technology,” Part II, Technology, Saunders and Frisch, Interscience Publishers, a division of John Wiley & Sons, New York, 1964; Encyclopedia of Polymer Science and Technology, Vol. 11, pages 506-563, New York, Interscience Publishers, 1969; and Oertel, Gunter (1985). Polyurethane Handbook. New York: Macmillen Publishing Co., Inc. Such references are herein incorporated by reference in its entirety.

The low tack viscoelastomeric gel material of the present invention is unique in that it is low tack and does not bleed. It was also determined that the low tack viscoelastomeric gel material resists ignition. This was a surprising discovery because no special flam retarding additives were used in the formula and the individual ingredients are generally combustible hydrocarbons.

Various examples of the low tack viscoelastomeric gel material can be formed by combining, by percent weight: about 50% to about 80% of a Polyol; about 3% to about 15% of an isocyanate; about 15% to about 40% of an oil; about 0.1% to about 1% of a catalyst; and about 0% to about 1% of a release agent. In one example, the oil comprises a vegetable oil, such as an epoxidized vegetable oil. In another example, the oil comprises a hydrocarbon oil.

One example liquid material composition set forth in Table 1 below:

TABLE 1

| | | Amount | |
|---|---|---|---|
| Ingredient Type | Ingredient Description | (grams) | Weight % |
| Polyol | 6000 molecular weight | 45 | 69% |
| | (nom.) EO capped poly | | |
| | propylene ether triol | | |
| Isocyanate | Liquid MDI eq. wt. 181 (nom.) | 3.9 | 6% |
| Plasticizer 1 | Soy Oil | 12.5 | 19% |
| Plasticizer 2 | Epoxidized Soy Oil | 2.5 | 4% |
| Catalyst | Organotin | 0.4 | 1% |
| Release Agent | Polydimethyl Siloxane 500 cs | 0.6 | 1% |
| | Total | 64.9 | 100% |

The ingredients may be combined, for example, as shown in FIG. 8 to produce a liquid material that may be dispensed to cure into an appropriate low tack viscoelastomeric gel material. As shown in Table 1 and FIG. 8, the base polymer is a polyurethane produced in-situ by the reaction of a polyol component(s) of the polyol blend and a isocyanate component(s) of the isocyanate blend. A unique combination of plasticizers contained in either or both of the polyol blend and or isocyanate blend softens the polyurethane polymer without causing it to become tacky as it becomes progressively softer. Catalyst is utilized to promote the reaction of the polyol and isocyanate components. Adjuvants such as silicone containing ingredients or low melting hydrocarbon based wax can be utilized to further reduce tack.

Once prepared, the liquid material can be dispensed and then cured into the low tack viscoelastomeric gel material which is comprised primarily of linear, branched or crosslinked viscoelastomeric polymer component(s) and specially formulated plasticizer component(s). Whereas the polymer component is an in-situ reaction product, catalysts may be beneficial. Adjuvants such as, colorants, release agents, odorants, viscosity modifiers, and the like may be included. The resulting low tack viscoelastomeric gel material is void of objectionable tackiness, is soft, does not dry out and or become harder with time nor does it leak or bleed ingredients into adjacent foam support structures or other structures. Further, even when exposed to a flame such as described in Underwriters Laboratory Test Procedure UL 94, the Standard for Safety of Flammability of Plastic Materials for Parts in Devices and Appliances testing, the low tack viscoelastomeric gel material was found to self extinguish after application of the flame.

One example of making the support structure will now be described. As shown in FIG. 3, a first layer 20 of foam material is provided with a first side including a plurality of protrusions 30 and a plurality of channels 40. Each of the protrusions are provided with a first support surface 32. The first layer 20 can be formed by widely known techniques with the desired shape, such as above-described shape including the peripheral wall 21, the interior area 16, protrusions 30 and channels 40.

The method of making the support structure can further include the step of preparing a liquid material. In one example, the liquid material is prepared, by percent weight, about 50% to about 80%, such as about 69% of Polyol; about 3% to about 15%, such as about 6% isocyanate; about 15% to about 40%, such as about 19% Soy Oil and about 4% Epoxidized Soy Oil; about 0.1% to about 1%, such as about 1% of a catalyst; and about 0% to about 1%, such as 1% of a release agent.

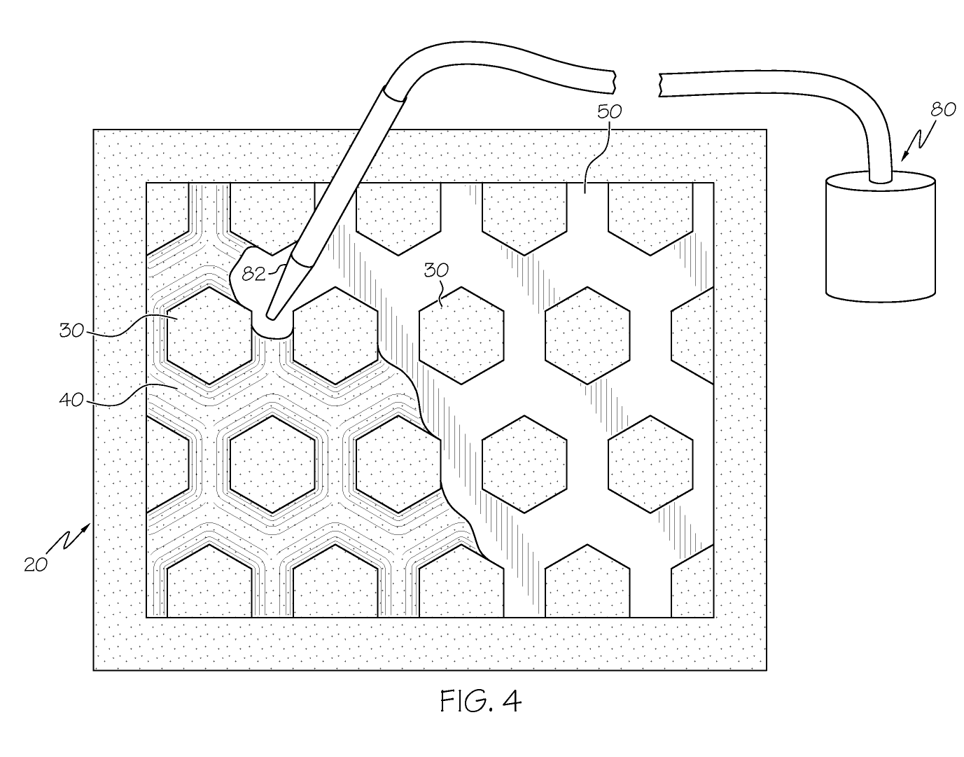

The method can further include the step of dispensing the liquid material into the plurality of channels 40 to a liquid level to at least partially fill the channels 40. The liquid material can be introduced into the channels 40, for example, by pouring and/or injecting the liquid material. For instance, with reference to FIG. 4, a schematic depiction of a liquid dispenser 80 is shown including a nozzle 82 used to introduce the liquid material into the channels 40. The liquid material can be introduced into the channels until the form shown in FIG. 2 is achieved. It will be appreciated that different amounts of liquid material can be provided to achieve the configurations shown in FIGS. 2A/2B, FIG. 5, FIG. 6 or other configurations. For instance, the method of making can include dispensing the liquid material such that the first support surface 32 of each protrusion 30 is positioned at a respective vertical distance above the liquid level.

Once dispensed, the liquid can partially permeate the porous surfaces of the channels to provide a subsequent strong bonding between the cured low tack viscoelastomeric material and the foam material. Moreover, optionally, the third layer may be provided before the liquid material has completely cured, thereby promoting at least partial permeation into the pores of the third layer to subsequently attach the third layer and first layers together as discussed more fully above.

The method of making the support structure can further include the step of curing the dispensed liquid into the second layer of low tack viscoelastomeric gel material such that the second support surface is formed at the liquid level. Optionally, the third layer 60 may be positioned over the first support surface 32 of the protrusions 30 and the second support surface 52 of the second layer 50 of low tack viscoelastomeric gel material after curing when bonding is not desired between the low tack viscoelastomeric gel material and the third layer 60.

In further examples, the second layer 50 may be preformed separately and then subsequently joined to the first layer 20. For example, a second layer 50 may be formed as a network of low tack viscoelastomeric gel material before introduction to the first layer 20. Then the network of low tack viscoelastomeric gel material may be placed such that each aperture 54 is aligned with a corresponding protrusion 30 of the first layer 20. Each protrusion is then at least partially inserted into the corresponding aperture 54 of the network of low tack viscoelastomeric gel material. Optionally, a layer of adhesive material may be used to join the cured low tack viscoelastomeric gel material to third layer and/or the first support surface.

The third layer 60 can be formed as a sheet of material configured to fit within the opening 16 into the interior area 16 of the first layer 20 of foam material. Due to the nature of the low tack viscoelastomeric gel material, the third layer 60 can be freely placed in a non-adhered fashion with respect to the second layer 50 of low tack viscoelastomeric gel material. Optionally, an adhesive may be used to attach first layer 20 to the third layer 60.

The second layer 50 of low tack viscoelastomeric gel material, the first layer 20 of foam material and the third layer 60 can be configured to provide the desired support characteristics for the particular application. Indeed, the amount of gel material can be provided such that excessive gel material is avoided that would otherwise add too much weight and/or cost to the support structure and/or provide too much firmness to the support structure. At the same time, sufficient gel material can be provided to provide enhanced support characteristics to provide a firmer support than would be available from an all-foam configuration. The first support surface 32 of the plurality of protrusions 30 can also form islands that are separated from one another by the gel material to provide a soft textured feel to the support structure. A wide range of relative dimensions can be used to optimize the overall and/or patterned firmness vs. softness characteristics (i.e., durometer) of the support structure. For example, as shown in FIGS. 2A and 2B, in just one example, the height (H) can be approximately 1½ inches, the distance (D₁) can be approximately ⅛ to ¼ of an inch, the distance (D₂) can be approximately ¼ to ½ of an inch, the distance (D₃) can be approximately ½ to ¾ of an inch, the width (WO can be approximately 1¼ to 1½ inches, and the width (W₂) can be approximately ½ to ¾ of an inch. An appropriate overall length (L) and width (W) may also be selected depending on the particular application. Further dimensions may be provided in further examples in accordance with aspects of the present invention. Accordingly, the dimensions listed above are just one example of dimensions that may be provided.

Examples of the disclosure can include a first aspect of a support structure comprising a first layer of foam material including a first side with a plurality of protrusions and a plurality of channels, wherein the protrusions each include a first support surface substantially facing a first direction. The support structure further includes a second layer of low tack viscoelastomeric gel material disposed within the plurality of channels, wherein the second layer includes a second support surface substantially facing the first direction and disposed laterally with respect to each first support surface.

In accordance with one example of the first aspect, the low tack viscoelastomeric gel material can comprise a non-bleeding viscoelastomeric gel material.

In accordance with another example of the first aspect, the low tack viscoelastomeric gel material is a polyurethane gel.

In accordance with a further example of the first aspect, the low tack viscoelastomeric gel material has a flame retarded property.

In accordance with yet another example of the first aspect, the low tack viscoelastomeric gel material is formed by combining, by percent weight: about 50% to about 80% of a Polyol; about 3% to about 15% of an isocyanate; about 15% to about 40% of an oil; about 0.1% to about 1% of a catalyst; and about 0% to about 1% of a release agent. In one example, the oil comprises a vegetable oil, such as an epoxidized vegetable oil. In another example, the oil comprises a hydrocarbon oil.

In accordance with yet another example of the first aspect, the first support surface of each protrusion is substantially flush with respect to the second support surface of the second layer.

In still another example of the first aspect, the first support surface of each protrusion is positioned at a respective vertical distance above the second support surface of the second layer.

In a further example of the first aspect, a third layer extends over the first support surface of the protrusions and the second support surface of the second layer.

In another example of the first aspect, the second support surface surrounds at least one of the plurality of protrusions.

In still another example of the first aspect, the plurality of channels comprises a network of channels surrounding at least one of the plurality of protrusions.

In still another example of the first aspect, the plurality of protrusions comprises an array of protrusions. For instance, the array of protrusions can comprise alternate rows of protrusions that are sequentially laterally offset from one another.

Any of the above examples of the first aspect, if provided, may be provided alone or in alternative combinations with one another with the first aspect.

Examples of the disclosure can also include a second aspect of a support structure comprising a first layer of foam material including a first side with a plurality of protrusions and a network of channels surrounding at least one of the plurality of protrusions, wherein the protrusions each include a first support surface substantially facing a first direction. The support structure further comprises a second layer of low tack viscoelastomeric gel material disposed within the network of channels, the second layer including a second support surface substantially facing the first direction and surrounding at least one of the plurality of protrusions, wherein the protrusions extend at least partially through the second layer with the second support surface disposed laterally with respect to each first support surface. The support structure still further includes a third layer extending over the first support surface of the protrusions and the second support surface of the second layer of low tack viscoelastomeric gel material, wherein the third layer includes a support surface substantially facing the first direction.

Any of the above examples of the first aspect, if provided, can also be provided alone or in alternative combinations with one other with the second aspect.

Examples of the disclosure can also include a third aspect of a support structure comprising a first layer of foam material including a first side with a plurality of protrusions that each include a first support surface substantially facing a first direction. The support structure can further include a second layer of low tack viscoelastomeric gel material including a second support surface substantially facing the first direction and disposed laterally with respect to each first support surface. The second layer includes a plurality of through apertures, wherein the second layer is bonded to the first side of the first layer with the plurality of protrusions each extending at least substantially through a corresponding aperture of the plurality of apertures. The low tack viscoelastomeric gel material is formed by combining, by percent weight: about 50% to about 80% of a Polyol, about 3% to about 15% of an isocyanate, about 15% to about 40% of an oil, about 0.1% to about 1% of a catalyst, and about 0% to about 1% of a release agent.

In one example of the third aspect, each aperture can include an interior surface bonded to the corresponding protrusion extending at least substantially through the aperture.

In another example of the third aspect, the first support surface of each protrusion is substantially flush with respect to the second support surface of the second layer.

In still another example of the third aspect, the first support surface of each protrusion is positioned at a respective vertical distance below the second support surface of the second layer.

In a further example of the third aspect, the first support surface of each protrusion is positioned at a respective vertical distance above the second support surface of the second layer.

In yet another example of the third aspect, a third layer extends over the first support surface of the protrusions and the second support surface of the second layer, wherein the third layer includes a support surface substantially facing the first direction. For instance, the third layer can comprise a foam material.

In a further example of the third aspect, the plurality of protrusions comprises an array of protrusions. For example, the array of protrusions comprises alternate rows of protrusions that are sequentially laterally offset from one another.

Any of the above examples of the third aspect, if provided, can also be provided alone or in alternative combinations with one another with the third aspect, and in some examples with the first and/or second aspect. In addition, or alternatively, many examples of the first aspect, if provided, can also be provided alone or in alternative combinations with one another with the third aspect.

Examples of the disclosure can also include a fourth aspect of a method of making a support structure comprising the steps of: providing a first layer of foam material including a first side with a plurality of protrusions and a plurality of channels, wherein the protrusions each include a first support surface; dispensing a liquid material into the plurality of channels to a liquid level; and curing the dispensed liquid into a second layer of low tack viscoelastomeric gel material such that a second support surface is formed at the liquid level.

In one example of the fourth aspect, the step of dispensing is conducted such that the first support surface of each protrusion is positioned at a respective vertical distance above the liquid level. In addition or alternatively, in another example of the fourth aspect, the method can further comprise the steps of applying a third layer of foam material over the first support surface of the protrusions and the second support surface of the second layer of low tack viscoelastomeric gel material.

Examples of the disclosure can also include a fifth aspect of a low tack viscoelastomeric gel material formed by combining, by percent weight: about 50% to about 80% of a Polyol; about 3% to about 15% of an isocyanate; about 15% to about 40% of an oil; about 0.1% to about 1% of a catalyst; and about 0% to about 1% of a release agent.

In one example of the fifth aspect, the oil comprises a vegetable oil, such as an epoxidized vegetable oil.

In another example of the fifth aspect, the oil comprises a hydrocarbon oil.

In another example of the fifth aspect, an exercise ball comprising the low tack viscoelastomeric gel material of the fifth aspect.

Examples of the disclosure can also include a sixth aspect of a method of making a low tack viscoelastomeric gel material comprising the steps of: dispensing a liquid material comprising, by percent weight of the liquid material: about 50% to about 80% of a Polyol, about 3% to about 15% of an isocyanate, about 15% to about 40% of an oil, about 0.1% to about 1% of a catalyst, and about 0% to about 1% of a release agent; and curing the dispensed liquid material into a low tack viscoelastomeric gel material.

In one example of the sixth aspect, the oil comprises a vegetable oil, such as an epoxidized vegetable oil.

In another example of the sixth aspect, the oil comprises a hydrocarbon oil.

In another example of the sixth aspect, an exercise ball comprising the low tack viscoelastomeric gel material of the sixth aspect.

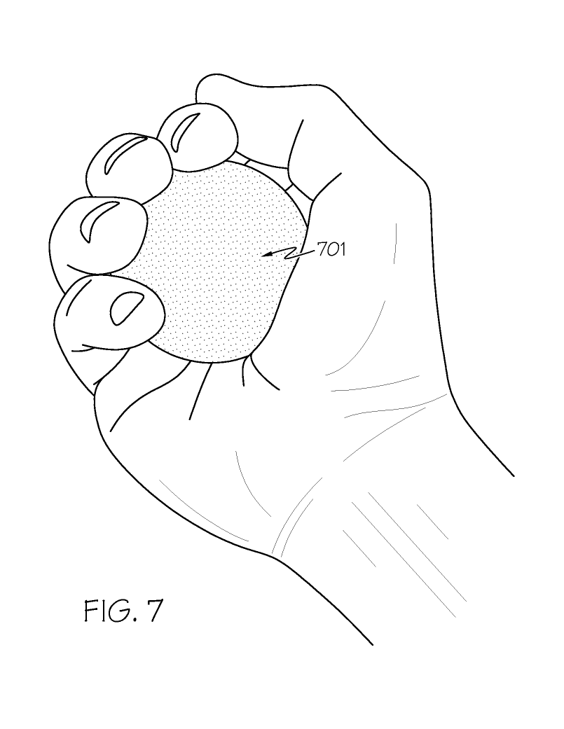

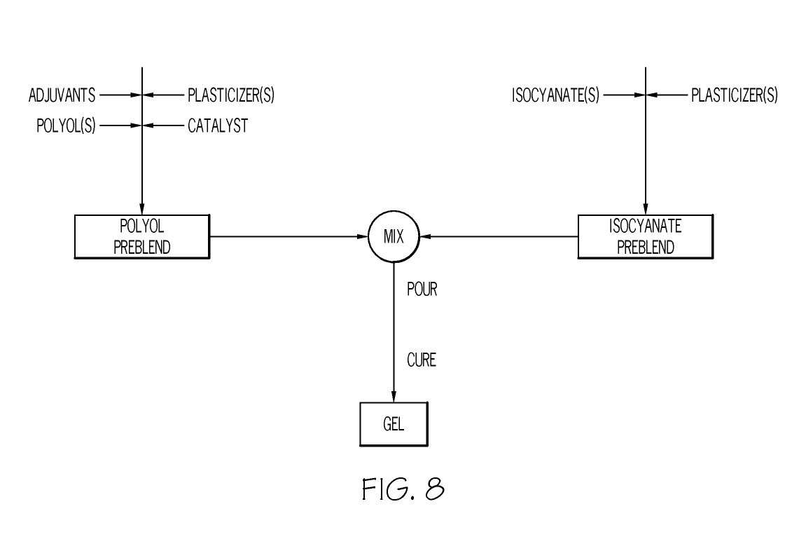

The low tack viscoelastomeric gel material of the present invention is unique in that it is inherently low tack and, in some examples, does not bleed. Viscoelastomeric gel material having inherently low tack is advantageous as it may facilitate unique designs and allow elimination of costly containment configurations such as membrane structures. For example, the viscoelastomeric gel material of the present invention allows direct manufacture of gel articles such the hand exercise ball 701 shown in FIG. 7, without secondary coating with talc and the like. These secondary operations not only add cost but lack durability, becoming tacky over time or if abraded such as cut to expose underlying portions of otherwise tacky material. Indeed, even if the surface is cut away, the underlying portions is likewise inherently low tack.

The invention has been described with reference to the example embodiments described above. Modifications and alterations will occur to others upon a reading and understanding of this specification. Examples embodiments incorporating one or more aspects of the invention are intended to include all such modifications and alterations insofar as they come within the scope of the appended claims.

What is claimed is:

1. A support structure comprising:
a first layer of foam material including a first side with a plurality of protrusions and a plurality of channels, wherein the protrusions each include a first support surface substantially facing a first direction; and
a second layer of low tack viscoelastomeric gel material disposed within the plurality of channels, wherein the second layer includes a second support surface substantially facing the first direction and disposed laterally with respect to each first support surface.

2. The support structure of claim 1, wherein the low tack viscoelastomeric gel material comprises a non-bleeding viscoelastomeric gel material.

3. The support structure of claim 1, wherein the low tack viscoelastomeric gel material is a polyurethane gel.

4. The support structure of claim 1, wherein the low tack viscoelastomeric gel material has a flame retarded property.

5. The support structure of claim 1, wherein the low tack viscoelastomeric gel material is formed by combining, by percent weight:
about 50% to about 80% of a Polyol;
about 3% to about 15% of an isocyanate;
about 15% to about 40% of an oil;
about 0.1% to about 1% of a catalyst; and
about 0% to about 1% of a release agent.

6. The support structure of claim 5, wherein the oil comprises a vegetable oil.

7. The support structure of claim 6, wherein the vegetable oil comprises an epoxidized vegetable oil.

8. The support structure of claim 5, wherein the oil comprises a hydrocarbon oil.

9. The support structure of claim 1, wherein the first support surface of each protrusion is substantially flush with respect to the second support surface of the second layer.

10. The support structure of claim 1, wherein the first support surface of each protrusion is positioned at a respective vertical distance above the second support surface of the second layer.

11. The support structure of claim 1, further comprising a third layer extending over the first support surface of the protrusions and the second support surface of the second layer.

12. The support structure of claim 1, wherein the second support surface surrounds at least one of the plurality of protrusions.

13. The support structure of claim 1, wherein the plurality of channels comprises a network of channels surrounding at least one of the plurality of protrusions.

14. The support structure of claim 1, wherein the plurality of protrusions comprises an array of protrusions.

15. The support structure of claim 14, wherein the array of protrusions comprises alternate rows of protrusions that are sequentially laterally offset from one another.

16. A method of making a support structure comprising the steps of:
providing a first layer of foam material including a first side with a plurality of protrusions and a plurality of channels, wherein the protrusions each include a first support surface;
dispensing a liquid material into the plurality of channels to a liquid level; and
curing the dispensed liquid into a second layer of low tack viscoelastomeric gel material such that a second support surface is formed at the liquid level.

17. The method of claim 16, wherein the step of dispensing is conducted such that the first support surface of each protrusion is positioned at a respective vertical distance above the liquid level.

18. A low tack viscoelastomeric gel material formed by combining, by percent weight:
about 50% to about 80% of a Polyol;
about 3% to about 15% of an isocyanate;
about 15% to about 40% of an oil;
about 0.1% to about 1% of a catalyst; and
about 0% to about 1% of a release agent.

19. An exercise ball comprising the low tack viscoelastomeric gel material of claim 18.

20. A method of making a low tack viscoelastomeric gel material comprising the steps of:
dispensing a liquid material comprising, by percent weight of the liquid material: about 50% to about 80% of a Polyol, about 3% to about 15% of an isocyanate, about 15% to about 40% of an oil, about 0.1% to about 1% of a catalyst, and about 0% to about 1% of a release agent; and
curing the dispensed liquid material into a low tack viscoelastomeric gel material.
